(19) United States
(12) Patent Application Publication
(10) Pub. No.: US 2015/0042797 A1
(43) Pub. Date: Feb. 12, 2015

(54) MOTOR VEHICLE REAR SIDE VIEW DISPLAY SYSTEM

(71) Applicant: GM Global Technology Operations LLC, Detroit, MI (US)

(72) Inventors: Muhammad F. Alam, Macomb, MI (US); Veshik Ponnam, Simi Valley, CA (US); Craig A. Lambert, Macomb, MI (US); Abuzafor M. Rasal, Hamtramck, MI (US)

(73) Assignee: GM Global Technology Operations LLC, Detroit, MI (US)

(21) Appl. No.: 13/960,362

(22) Filed: Aug. 6, 2013

(51) Int. Cl. B60R 11/04

(52) U.S. Cl. CPC B60R 11/04
USPC 348/148

(57) ABSTRACT

A motor vehicle includes a body having a front end, a rear end, a first side extending between the front end and the rear end and a second, opposing side extending between the front end and the rear end. A side view mirror is mounted at the body. The side view mirror includes a reflective surface and a video display arranged behind the reflective surface. The side view mirror is selectively adjustable to provide a view along the first side. A camera is mounted at the body and operatively connected to the video display. The camera is configured and disposed to provide a first side rear view behind the rear end to the video display.

### FIELD OF THE INVENTION

The subject invention relates to the art of motor vehicles and, more particularly, to a motor vehicle having a rear side view display system.

### BACKGROUND

Traditionally, motor vehicles include a rear view mirror and one or two side view mirrors. The rear view mirror, as the name implies, provides a driver with a view behind the motor vehicle. The side view mirror(s) provide the driver with a view along one or both sides of the motor vehicle. Recently, many motor vehicles have been provided with rear looking cameras that broadcast a behind the vehicle view to a dashboard display. Typically, the camera is mounted centrally on a rear portion of the motor vehicle; often times over or around a license plate mounting zone. The rear view camera provides a good view of what is located centrally behind the vehicle. That view however may include dead zones, or areas of minimal coverage at rear corner portions of the vehicle that are also minimally perceivable through side view mirrors. Accordingly, it is desirable to provide a system that enables a driver to clearly view not only what is located directly behind a motor vehicle, but also what is located at rear side portions of the motor vehicle.

### SUMMARY OF THE INVENTION

In accordance with an exemplary embodiment, a motor vehicle includes a body having a front end, a rear end, a first side extending between the front end and the rear end and a second, opposing side extending between the front end and the rear end. A side view mirror is mounted at the body. The side view mirror includes a reflective surface and a video display arranged behind the reflective surface. The side view mirror is selectively adjustable to provide a view along the first side. A camera is mounted at the body and operatively connected to the video display. The camera is configured and disposed to provide a first side rear view behind the rear end to the video display.

In accordance with another exemplary embodiment, a method of displaying a rear corner view of a motor vehicle includes capturing an image at a rear corner of the motor vehicle, transmitting the image to a display provided in a side view mirror, and displaying the image on the display.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a top view of a motor vehicle having a rear side view camera system in accordance with an exemplary embodiment;

FIG. 2 is a left side view of the motor vehicle of FIG. 1;

FIG. 3 is a detailed view of a left side view mirror of the motor vehicle of FIG. 1;

FIG. 4 is a right side view of the motor vehicle of FIG. 1;

FIG. 5 is a detailed view of a right side view mirror of the motor vehicle of FIG. 1;

FIG. 6 is a detailed view of a rear end of the motor vehicle of FIG. 1; and

FIG. 7. is a partial detailed left side view of the motor vehicle of FIG. 1

### DESCRIPTION OF THE EMBODIMENTS

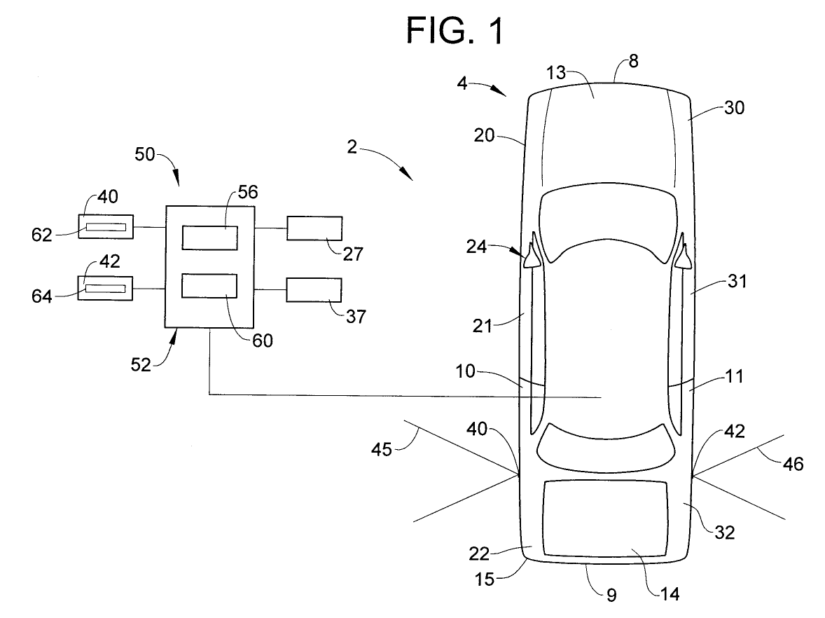

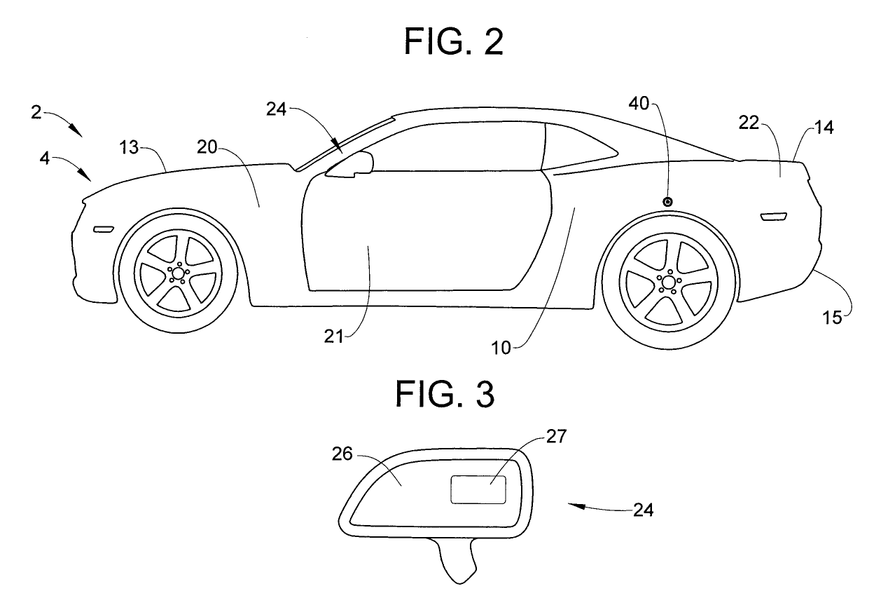

The following description is merely exemplary in nature and is not intended to limit the present disclosure, its application or uses. It should be understood that throughout the drawings, corresponding reference numerals indicate like or corresponding parts and features. A motor vehicle, in accordance with an exemplary embodiment, is indicated generally at 2, in FIG. 1. Motor vehicle 2 includes a body 4 having a front end 8, a rear end 9, a first or left side 10 and a second or right side 11. Front end 8 includes a hood 13 and rear end 9 includes a trunk lid 14 and a rear bumper 15 (FIG. 2).

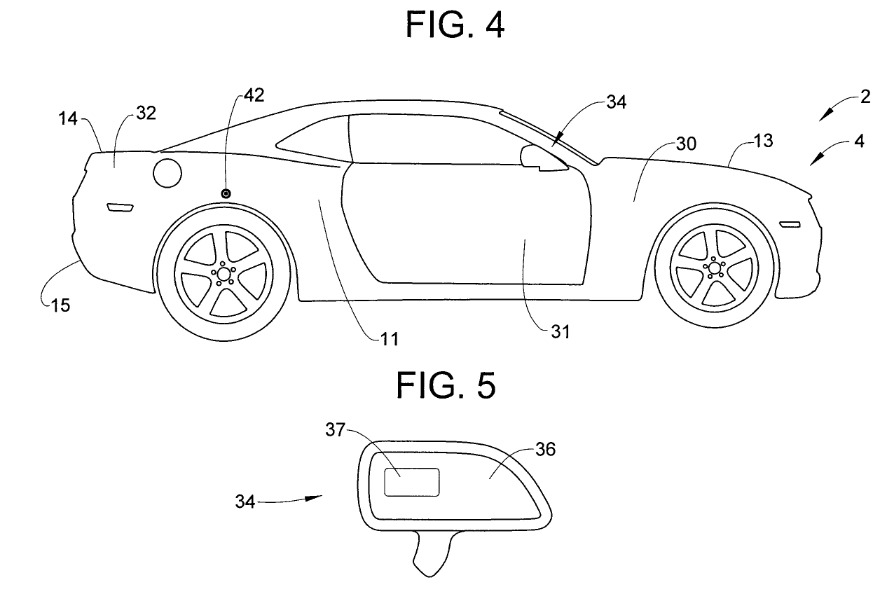

In accordance with an exemplary embodiment illustrated in FIG. 2, first side 10 includes a left side front fender 20 a left side door 21 and a left side quarter panel 22. A first or left side view mirror 24 is mounted to left side door 21. As seen in FIG. 3, first side view mirror 24 includes a selectively reflective surface 26 and a display 27. Display 27 is arranged behind selectively reflective surface 26. Similarly, as shown in FIG. 4, second side 11 includes a right side front fender 30, a right side door 31, and a right side quarter panel 32. A second or right side view mirror 34 is mounted to right side door 31. As shown in FIG. 5, right side view mirror 34 includes a selectively reflective surface 36 and a display 37. Display 37 is arranged behind selectively reflective surface 36. In further accordance with an exemplary embodiment, motor vehicle 2 includes a first rear side view camera 40 and a second rear side view camera 42. First rear side view camera 40 is mounted at body 4 along left side 10 and provides a first side view 45 laterally outward of motor vehicle 2. Second side view camera 42 is mounted at body 4 along right side 11 and provides a second side view 46 laterally outward of motor vehicle 2. More specifically, first camera 40 is mounted on left side 10 near rear end 9 above a left rear tire (not separately labeled) and second camera 42 is mounted at right side 11 near rear end 9 above a right rear tire (also not separately labeled).

In further accordance with an exemplary embodiment, motor vehicle 2 includes a rear side view display system 50 operatively connected to first and second cameras 40 and 42 and first and second displays 27 and 37. Display system 50 includes a controller 52 having a central processor unit 56 and an image processor unit 60. When motor vehicle 2 is in reverse, display system 50 receives real time video images from first and second cameras 40 and 42. The image from camera 40 is passed through image processor 60 and sent to display 27 and the image from camera 42 is passed through image processor 60 and sent to display 37. Each camera 40 and 42 may include a corresponding variable zoom 62 and 64 that provides image enhancement. Each variable zoom 62 and 64 may be controlled by an operator of motor vehicle 2 or through an algorithm provided in controller 52. A portion of selectively reflective surface 26 ceases to be reflective when an image is sent to display 27. Similarly, a portion of selectively reflective surface 36 ceases to be reflective when an image is sent to display 37. In this manner, a driver can view left and right side view mirrors 24 and 34 and not only see a reflected image of an area behind motor vehicle 2, but can also view processed images of areas to the left and right sides of motor vehicle 2. Display system 50 provides enhanced driver operational awareness, increasing motor vehicle safety.

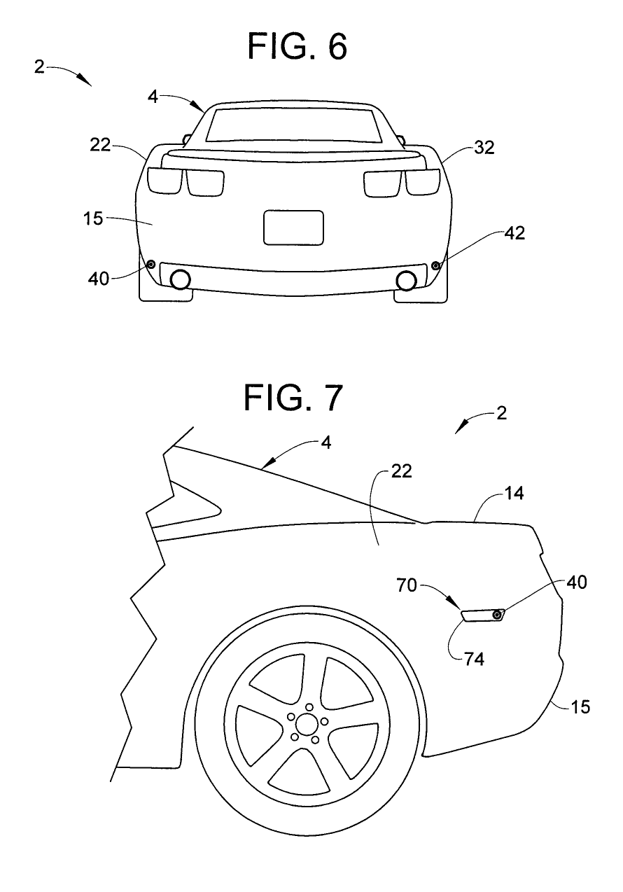

FIG. 6, wherein like reference numbers represent corresponding parts in the respective views, illustrates first and second cameras 40 and 42 mounted in rear bumper 15. FIG. 7, wherein like reference numbers represent corresponding parts in the respective views, illustrates first camera 40 mounted in a side marker or taillight 70 of motor vehicle 2. In the exemplary embodiment shown, taillight 70 takes the form of a left side turn signal light 74. However, it should be understood that taillight 70 may also take the form of a brake light, a reflector, or the like. It should also be understood that second camera 44 may be mounted in a similar location on right side 11.

At this point it should be understood that the exemplary embodiments describe a rear side view display system for a motor vehicle. Left and right rear mounted cameras provide real time video images to left and right side view mirror displays. The images increase situational awareness providing a driver with information regarding on-coming vehicles, pedestrians, or the like, that may otherwise not be viewable through traditional side view or rear view mirrors. It should also be understood that the location of the rear side view cameras may vary depending on motor vehicle model. Further, it should be understood that the location of the display with respect to the reflective surface may vary. Finally, it should be understood that a driver may be provided with an override system to disable the display system if so desired.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A motor vehicle comprising:
a body having a front end, a rear end, a first side extending between the front end and the rear end and a second, opposing side extending between the front end and the rear end;
a side view mirror mounted at the body, the side view mirror including a reflective surface and a video display arranged behind the reflective surface, the side view mirror being selectively adjustable to provide a view along the first side; and
a camera mounted at the body and operatively connected to the video display, the camera being configured and disposed to provide a first side rear view behind the rear end to the video display.

2. The motor vehicle according to claim 1, wherein the camera is mounted to the first side of the motor vehicle.

3. The motor vehicle according to claim 1, wherein the camera is mounted at the rear end of the motor vehicle.

4. The motor vehicle according to claim 3, further comprising: a bumper mounted at the rear end, the camera being mounted in the bumper.

5. The motor vehicle according to claim 3 further comprising: a taillight mounted at the rear end at the first side, the camera being mounted at the taillight.

6. The motor vehicle according to claim 5, wherein the camera is integrated into the taillight.

7. The motor vehicle according to claim 1, further comprising:
another side view mirror mounted at the body, the another side view mirror including a reflective surface and a video display arranged behind the reflective surface, the another side view mirror being selectively adjustable to provide a view along the second side; and
another camera mounted at the body and operatively connected to the video display of the another side view mirror, the camera being configured and disposed to provide a second side rear view behind the rear end to the video display.

8. The motor vehicle according to claim 7, wherein the another camera is mounted to the second side of the motor vehicle.

9. The motor vehicle according to claim 7, wherein the another camera is mounted at the rear end of the motor vehicle.

10. The motor vehicle according to claim 9, further comprising: a bumper mounted at the rear end, the another camera being mounted in the bumper.

11. The motor vehicle according to claim 9, further comprising: another taillight mounted at the rear end at the second side, the another camera being mounted at the another taillight.

12. The motor vehicle according to claim 11, wherein the another camera is integrated into the another taillight.

13. A method of displaying a rear corner view of a motor vehicle comprising:
capturing an image at a rear corner of the motor vehicle;
transmitting the image to a display provided in a side view mirror; and
displaying the image on the display.

14. The method of claim 13, wherein capturing the image at the rear corner of the motor vehicle includes capturing an image of a left rear corner of the motor vehicle.

15. The method of claim 13, wherein displaying the image on the display includes displaying the image in a left side view mirror.

16. The method of claim 13, wherein capturing the image at the rear corner of the motor vehicle includes capturing a first image at a left rear corner of the motor vehicle and capturing a second image at a right rear corner of the motor vehicle.

17. The method of claim 16, wherein displaying the image on the display includes displaying the first image in a left side view mirror and displaying the second image in the right side view mirror.

18. The method of claim 13, wherein displaying the image on the display includes presenting the image on a display mounted behind a selectively reflective surface of the side view mirror.

19. The method of claim 13, wherein capturing the image of the rear corner of the motor vehicle includes capturing an image through a camera mounted to a side of the motor vehicle.

20. The method of claim 13, wherein capturing the image of the rear corner of the motor vehicle includes capturing an image through a camera mounted at a taillight of the motor vehicle.
